(19) United States
(12) Patent Application Publication
(10) Pub. No.: US 2025/0025372 A1
(43) Pub. Date: Jan. 23, 2025

(54) Apparatus, device, and method for powering portable massager with an external power source such as a mobile phone

(71) Applicant: Vladislav Kofman, Brooklyn, NY (US)

(72) Inventor: Vladislav Kofman, Brooklyn, NY (US)

(73) Assignee: Cardinalis Group Inc., Brooklyn, NY (US)

(21) Appl. No.: 18/443,845

(22) Filed: Feb. 16, 2024

Related U.S. Application Data
(60) Provisional application No. 63/515,118, filed on Jul. 23, 2023.

(51) Int. Cl. A61H 23/02; H04M 1/21

(52) U.S. Cl. CPC A61H 23/0263; H04M 1/21; A61H 2201/0157; A61H 2201/501

(57) ABSTRACT

The invention is a portable electric massager, which does not contain an internal power source, and can be used with and powered by a mobile device, such as a mobile phone or similar device capable of providing electric power output. It belongs to the field of personal portable massaging devices, particularly automated vibrating devices for applying automated vibrations to body parts and tissues. One embodiment is a device for applying vibration to a body part or tissue of the user, the device comprising a vibratory motor with an eccentric rotating mass counterweight; a body enclosing the vibrating mechanism, and a part that is used to mount, grip, and hold the power source, such as mobile phone, used to power the motor.

### FIELD OF INVENTION

Apparatus or processes which are not used for surgical purposes utilizing mechanical energy directly applied upon human bodies by physical contact (e.g. massage) to rub, stroke, knead, tap, vibrate, or otherwise move a portion of the external surface of human bodies, or the surfaces of their naturally occurring body cavities, to either: physically relax, physically stimulate, or counteract or relieve bodily pains.

### BACKGROUND

Conventional personal massages are commonly used by users for massaging a portion(s) of the user's own body to physically relax, stimulate, or counteract or relieve bodily pains. Such conventional personal massagers are either purely mechanical or electric personal massagers. The electric personal massagers unitize an internal power source to convert electric energy into mechanical energy to be applied to the user's body. Thud, the electric personal massagers must contain an internal power source to supply the electric motor with power. The conventional internal power source is either a rechargeable battery such as lithium-ion (Li-ion), zinc-ion, sodium-ion, lithium-sulfur or solid-state batteries which need to be periodically recharged, or a non-rechargeable, such as alkaline batteries, which need to be periodically replaced.

Having an internal power source (e.g. a battery) in an electric personal massager requires users to maintain a certain level of power within the device for it to be operational. Therefore, a need exists for a personal massager that does not contain an internal power source and can use an external power source, such as ubiquitous conventional personal mobile devices, such as mobile phones or tablets. This invention is an electric personal massager which provides this need.

### DETAILED DESCRIPTION OF THE INVENTION

Described herein is the device for applying vibration to a body part or tissue of a user, more specifically a personal portable massager, used for automated massages, used in conjunction with a mobile phone or similar device to power the vibration mechanism. The device itself does not contain a power source such as a rechargeable battery. The embodiment of the invention consists of two parts, operated independently and if desired by the user can be assembled and used as one device. Specifically mobile phone holder part with gripping handles and the massager part housing the eccentric rotating mass motor and the wire to connect to the mobile power source, such as mobile phone supporting power output, which can be used independently without the holder part. One embodiment of the invention described uses USB Type-C® and USB-C® connection and protocol for power delivery, other embodiments may use similar Universal Serial Bus (USB) power delivery protocols but via different USB connectors, or a Lightning® connector and corresponding power protocol.

It is accordingly the goals of this detailed description of the invention to cover a device having all of the advantages and benefits set forth above and described in greater detail hereinafter in this application.

This version of the massager is remarkably simple in its structure so it is economical to manufacture and does not require lithium-ion researchable batteries or any kind of chemically based batteries internally. In one embodiment of the invention, the interior rigid structure enclosing eccentric rotating counterweight mass motor, relay electronics, required wiring, and control module may be formed of molded plastic, and the exterior may be a single piece of soft silicone or similar material. The part used to hold a mobile device, which will provide the power source, can be formed from high-grade plastic, metal, or similar rigid materials.

In one embodiment of the invention, the eccentric rotating mass motor may be operated at different speeds or rotation patterns, e.g. at low or high speeds, controlled by the on/off button. The on/off button may be used to turn on the device, but the action of plugging or unplugging the device to or from the mobile phone (or similar power source) can itself be equivalent to turning the massager on or off, without the need of the user to press any buttons.

Furthermore, the device may be applied to a body part to apply targeted vibration, by bringing the device in contact with the body part, to produce a light or deep tissue stimulation, and is not limited to one specific body part.

This invention and description also comprise other capabilities related to this type of device, without an internal power source, as may later fully appear and which are inherently possessed by the invention. The one preferred embodiment described herein is primarily a massaging device, but other applications are possible.

### DESCRIPTION OF THE DRAWINGS

While the accompanying drawings demonstrate the preferred embodiment of the invention, it should be understood that the same is susceptible to modification and change without departing from the spirit of the invention, such as a change in the shape of the motor enclosing part, or power delivery protocol.

The drawings are not to exact scale. The drawings are not intended to portray specific sizes or parameters of the parts of the invention and should be considered merely representations. The drawings are intended to depict example embodiments of the invention, and therefore should not be considered as limiting in scope, but represent the essence of the invention. In the drawings, the same numbering may represent like elements. Furthermore, certain elements in some of the figures may be not labeled due to overlay with other depicted elements, or depicted not-to-scale, for explanatory clarity only.

FIG. 1 is a complete view of the embodiment of the invention showing the mobile device (for illustration purposes only), mobile device holder, and the attached massager.

FIG. 2 is a complete view of the embodiment of the invention showing, the massager itself and the mobile phone holder as separate parts.

FIG. 3. shows only the part that would hold the mobile phone and can have extending handles using a spring or similar mechanism to accommodate different sizes of mobile phones or similar devices.

FIG. 4. shows a cross-section of the part that would hold the eccentric rotating mass counterweight motor and supporting internal structures, without a power source.

### DESCRIPTION OF THE PREFERRED EMBODIMENT

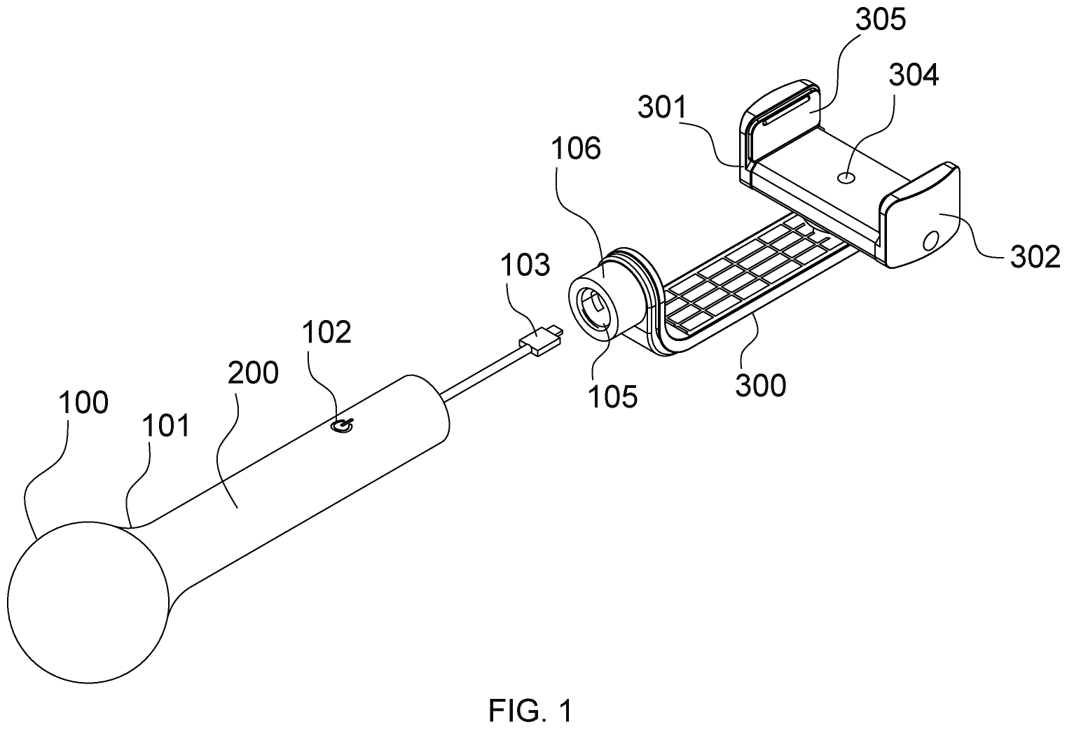

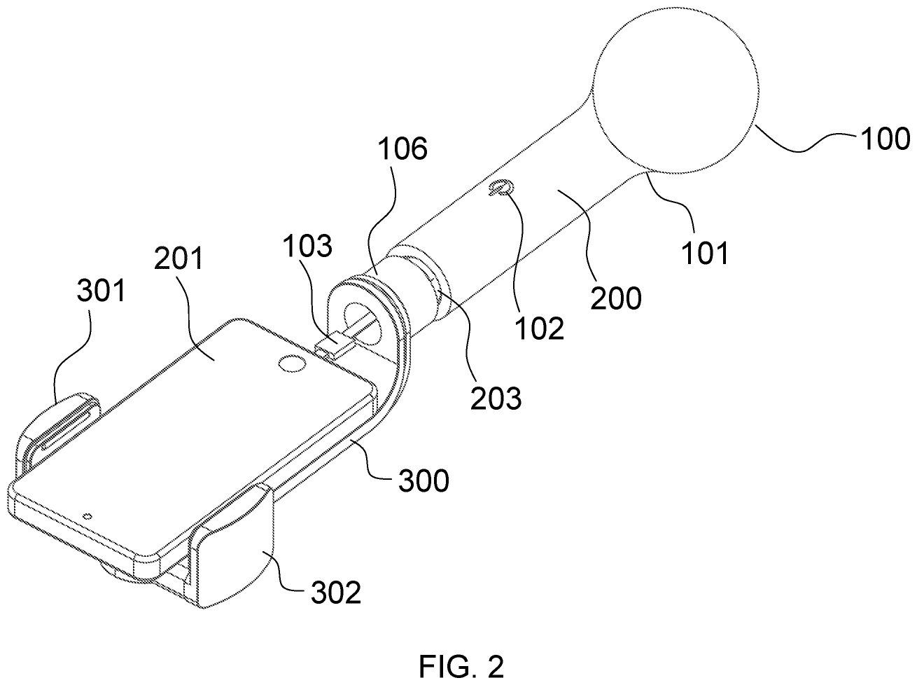

Referring to FIG. 1 through FIG. 4 of the drawings, the device works by applying massaging forces to the user's body, the device comprises a generally bar-shaped elongated body 200 having a rounded top section 100 which houses a motor 401 with an eccentric rotating mass counterweight 406, middle section 200 housing required wiring 405 and control module 403 and an attachable bottom part 300 for holding mobile device, such as mobile phone 201.

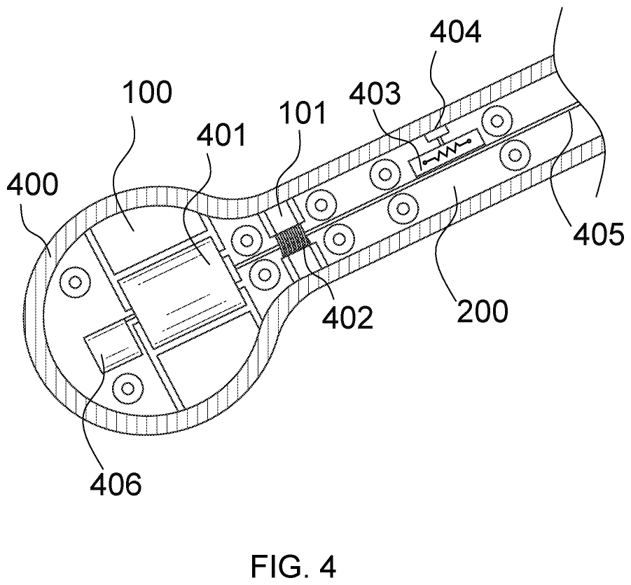

One embodiment which has been selected to illustrate this invention comprises rounded top part 100 enclosing an eccentric rotating mass 406 motor 401, which may be conveniently formed of molded plastic or other suitable rigid material, a flexible shaft or neck 101 without any plastic inside FIG. 4 or having flexible spring based element 402 and an elongated handle or middle part 200 housing small electronics control board 403, with required wiring and control module and the on/off switch 102 & 404, and the bottom part 300 designed to hold the mobile phone 201 (power source) and be attached to the middle part 200 via the interlocking shaft 106 & 105.

The top section 100 has a rounded design to deliver massaging force to a user's body part when this top part is positioned in contact with the user's body; the top 100 and middle 200 sections are separated by an internal flexible shaft 101 allowing the vibration force to be concentrated in the top section 100 and dissipate with the middle section 200 and the mobile phone holder 300, if fully assembled. The middle section 200 has required wiring 405 with connector 103 compatible with the separate power source 201, such as, but not limited to USB (USB-C®) or Apple Lightning® connectors.

In embodiment, motor controller switch 404 receives signals from the user and controls the desired operating speed, frequency of the vibration, or intensity of the vibration. The motor 401, once set to the specific mode, provides a consistent power draw and speed. The draw of power from the external power source 201 is also consistent and is not affected by the external mobile power source battery levels or remaining life.

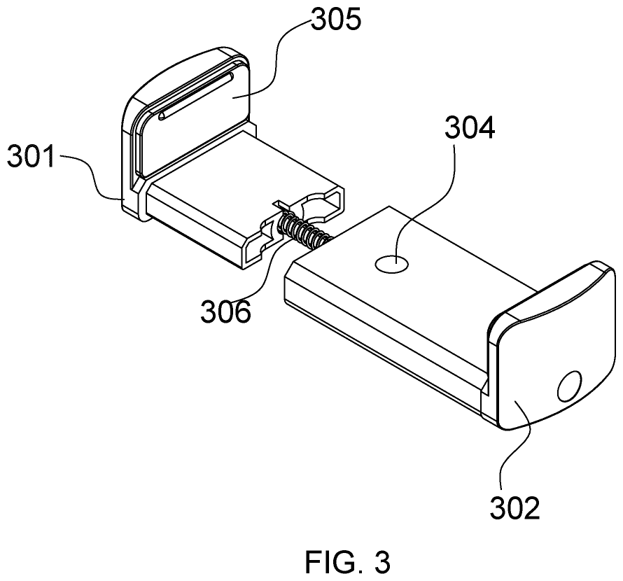

The bottom section of the device referring to FIG. 3, is designed to mount and hold the energy source, such as mobile phone 201, securely in place; with stretchable gripping single arm or both arms 301 & 302, which have extra flexible pads 305, to increase friction and hold the mobile phone 201, securely in place. The middle 200 and bottom 300 parts may be connected or joined together using the male-female type assembly 105 & 203 which would rotate and lock in place, creating one rigid structure. The preferred embodiment of this device does not represent a mobile phone stand or mounting or affixing this device or any part of this device inside of a motor vehicle.

Part FIG. 3 holding the mobile phone 201 in place or a similar power source is attached via a plastic or metal pin 304 to the bottom part 300. The part holding the mobile phone (or similar power source such as small tables) FIG. 3 would be able to rotate, in the currently preferred embodiment, by utilizing pin 304 and have a specific fixed orientation and rotation of the mobile phone based on the user's preference.

Referring to FIG. 4 of the drawings, the top part 100 housing or encasing the eccentric rotating mass 406 motor 401, is encased in rigid plastic and a single piece of soft silicone or similar material 400, connected via flexible shaft 101, housing a flexible element such as spring 402, to the elongated middle part 200, which is housing motor controller on/off switch 404 and the electronics circuit board 403 and no internal power source. The electrical connection wires 405 are shown to demonstrate the simplicity of the approach, and they only connect an eccentric rotating mass 406 counterweight motor 401 with the electronics circuit board 403, the on/off switch 404, and the external plug 103, that is used to connect to the external power source such as mobile phone 201.

The current illustrations are intended to represent the one embodiment of the invention without departing from the spirit, scope, and purpose of the invention. Thus, it is intended that the present invention cover the modifications and variations of this invention provided they come within the scope of the appended claims and their equivalents. Reference will now be made to the claims of the invention.

1. A portable electric massager that consists of a mobile phone holder and a vibrating module, the vibrating part does not have an independent internal power source such as a battery but is powered via an external power source such as a mobile phone.

2. The structure described in claim 1, in which the rounded end is hollow and free to vibrate without dampening engagement with any other portion of the massager.

3. The structure described in claim 1, in which the mobile device holder part is free to be attached or detached from the part with the motor (removably mounted bottom section) which has the capabilities to grip, hold, and rotate the phone.
